(19) United States
(12) Patent Application Publication
(10) Pub. No.: US 2004/0231209 A1
(43) Pub. Date: Nov. 25, 2004

(54) Illuminated vehicle sign

(76) Inventor: Ernest H. Love, Henderson, KY (US)

Correspondence Address: Ernest H. Love, 1321 Madison Street, Henderson, KY, 42420, US

(21) Appl. No.: 10/439,824

(22) Filed: May 19, 2003

(51) Int. Cl. G09F 13/02

(52) U.S. Cl. 40/591; 40/204

(57) ABSTRACT

An illuminated vehicle sign for signaling following motorists. The illuminated vehicle sign includes a housing, electrical power device, activating device and illuminating device. The housing has a face plate, back plate, signal receiver, integrated timer circuit and peripheral wall which extends between and is integrally coupled to the faceplate and backplate. The signal receiver and integrated timer circuit are mounted between the face plate and back plate. The face plate has illuminated Alpha-numeric characters which are illuminated upon activation of the activating device. The illumination of the Alpha-numeric characters is activated from a portable transmitter through a receiver and integrated timer circuit which subsequently activates the illuminating Alpha-numeric characters. The illumination of the Alpha-numeric characters can be powered by either battery or by means of the vehicular electrical system.

### BACKGROUND OF THE INVENTION

1. The present invention relates to illuminated sign devices and more particularly pertains to a new illuminated vehicle sign for signaling following motorists.

2. The use of illuminated sign devices is known in prior art. More specifically, illuminated sign devices heretofore devised and utilized for vehicles are known to consist basically of the familiar, expected and obvious structural configurations relevant to illuminating a vehicular license plate type sign. These devices are further known to basically consist of frames mounted around or on the license plate type signs to illuminate the sign.

While these devices fulfill their respective, particular objectives and requirements, they do not disclose a new illuminated vehicle sign. The inventive device includes a housing, electrical power device, activating device and illuminating device. The housing has a face plate, back plate, signal receiver, integrated timer circuit and peripheral wall which extends between and is integrally coupled to the faceplate and backplate. The signal receiver and integrated timer circuit are mounted between the face plate and back plate. The face plate has illuminated Alpha-numeric characters which are illuminated upon activation of the activating device. The illumination of the Alpha-numeric characters is activated from a portable transmitter through a receiver and integrated timer circuit which subsequently activates the illuminating Alpha-numeric characters. The illumination of the Alpha-numeric characters can be powered by either battery or by means of the vehicular electrical system.

In these respects, the illuminated vehicle sign according to the present invention substantially departs from the conventional concepts and designs of prior art, and in so doing provides an apparatus primarily developed for the purpose of signaling following motorists.

### SUMMARY OF THE INVENTION

In view of the forgoing disadvantages inherent in the known types of illuminated sign devices now present in prior art, the present invention provides a new illuminated vehicle sign construction wherein the same can be utilized for signaling following motorists. The general purpose of the present invention, which will be described subsequently in greater detail, is to provide a new illuminated vehicle sign apparatus and method which has many of the advantages of the illuminated sign devices mentioned heretofore and many novel features that result in a new illuminated vehicle sign which is not anticipated, rendered obvious, suggested, or even implied by any for the prior art illuminated sign devices, either alone or in any combination thereof.

To attain this, the present invention generally comprises a housing, electrical power device, activating device and illuminating device. The housing has a face plate, back plate, signal receiver, integrated timer circuit and peripheral wall which extends between and is integrally coupled to the faceplate and backplate. The signal receiver and integrated timer circuit are mounted between the face plate and back plate. The face plate has illuminated Alpha-numeric characters which are illuminated upon activation of the activating device. The illumination of the Alpha-numeric characters is activated from a portable transmitter through a receiver and integrated timer circuit which subsequently activates the illuminating Alpha-numeric characters. The illumination of the Alpha-numeric characters can be powered by either battery or by means of the vehicular electrical system.

There has thus been outlined rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the forgoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new illuminated vehicle sign apparatus and method which has many of the advantages of the illuminated sign devices mentioned heretofore and many novel features that result in a new illuminated vehicle sign which is not anticipated, rendered obvious, suggested, or even implied by any prior art illuminated sign devices, either alone or in any combination thereof.

It is another object of the present invention to provide a new illuminated vehicle sign which may be easily and efficiently manufactured and marketed.

It is a further object of the present invention to provide a new illuminated vehicle sign which is of a durable and reliable construction.

An even further object of the present invention is to provide a new illuminated vehicle sign which is susceptible of a low cost of manufacture with regard to both materials and labor, and which accordingly is then susceptible of low prices of sale to the consuming public, thereby making such illuminated vehicle sign economically available to the buying public. Still another object of the present invention is to provide a new illuminated vehicle sign for signally following motorists.

Yet another object of the present invention is to provide a new illuminated vehicle sign which includes a housing, electrical power device, activating device and illuminating device. The housing has a face plate, back plate, signal receiver, integrated timer circuit and peripheral wall which extends between and is integrally coupled to the faceplate and backplate. The signal receiver and integrated timer circuit are mounted between the face plate and back plate. The face plate has illuminated Alpha-numeric characters which are illuminated upon activation of the activating device. The illumination of the Alpha-numeric characters is activated from a portable transmitter through a receiver and integrated timer circuit which subsequently activates the illuminating Alpha-numeric characters. The illumination of the Alpha-numeric characters can be powered by either battery or by means of the vehicular electrical system.

Even still another object of the present invention is to provide a new illuminated vehicle sign that is easily portable and may be stored in a small area in emergency vehicles.

For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic perspective view of a new illuminated vehicle sign mounted to the rear of a vehicle according to the present invention.

FIG. 2 is a schematic perspective view of the housing and illuminating device of a new illuminated vehicle sign.

### DESCRIPTION OF THE PREFERRED EMBODIMENT

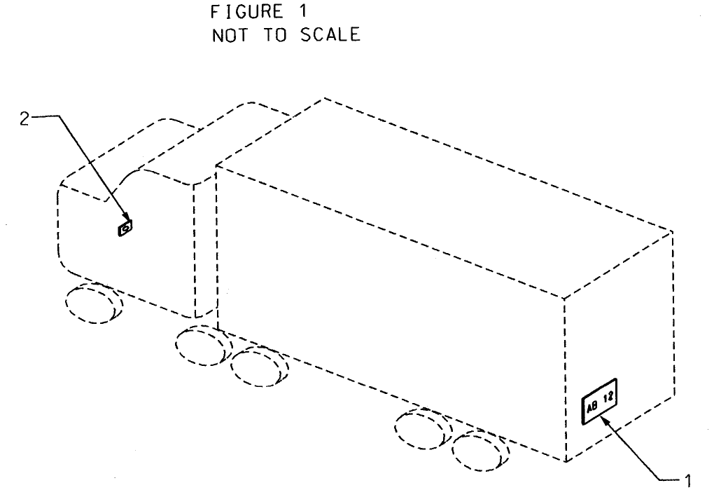

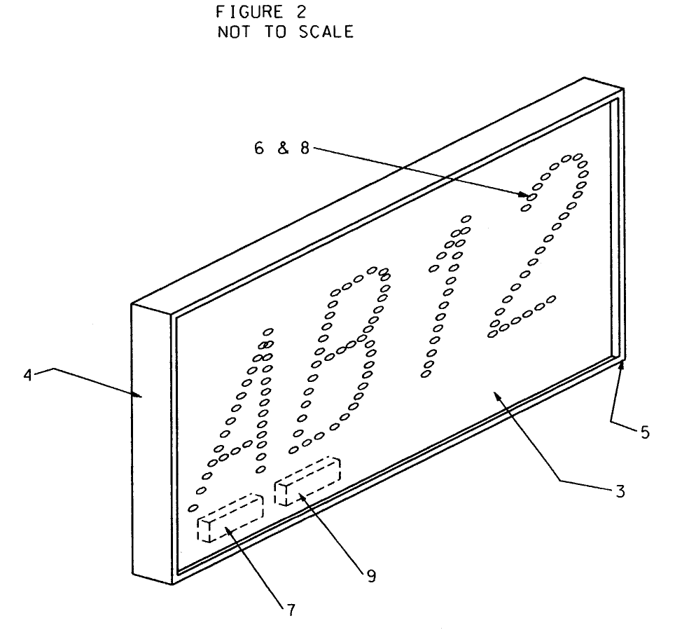

With reference now to the drawings, and in particular to FIGS. 1 and 2 thereof, a new illuminated vehicle sign will be described.

As best illustrated in FIGS. 1 and 2, the illuminated vehicle sign generally comprises a housing 1 and an activating device 2. The housing has a face plate 3, back plate 4, radio frequency receiver 9, integrated timer circuit 7 and peripheral wall 5 which extends between and is integrally coupled to the faceplate 3 and back plate 4. The radio frequency receiver 9 and the integrated timer circuit 7 are mounted between the face plate 3 and the back plate 4. The face plate 3 has illuminated Alpha-numeric characters 6 which are illuminated upon activation of the activating device 2. The illumination of the Alpha-numeric characters 6 is from the activating device 2 through the radio frequency receiver 9 and to an integrated timer circuit 7 which subsequently activates the illuminating Alpha-numeric characters 6. The illumination of the Alpha-numeric characters 6 can be powered by either battery or by means of the vehicular electrical system.

The preferred material for the face plate 3, back plate 4 and the peripheral wall 5 comprises a plastic; however, it can be of any suitably rigid material. The preferable size of the housing 1 is suitable for optimum size Alpha-numeric characters 6 which are legible at a safe following distance for the following motorists and can be varied depending upon the message to be delivered.

The preferred illuminating device 8 is light-emitting diodes (LED's); however, any appropriate illuminating device 8 can be incorporated into the present invention.

The preferred activating device 2 is portable, hand-held radio frequency transmitter.

The preferred method of mounting the housing 1 is by use of magnets.

As to further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the forgoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An Illuminated Vehicle Sign device, said device comprising; a housing having a face plate, a back plate, signal receiver, integrated timer circuit and a peripheral wall extending between and integrally coupled to said face plate and back plate; an illuminating device mounted to the face plate or mounted between the face plate and back plate with the face plate being a clear material or the face plate is pierced allowing the illuminating device to penetrate the face plate; that the device illuminates in Alpha-numeric characters; a power source for the illuminating device and activating device which can be either battery or the vehicular power source; a portable transmitter that when activated, signals a receiver and powers an integrated timing circuit that further powers the illuminating device.
